(19) United States
(12) Patent Application Publication
(10) Pub. No.: US 2007/0216516 A1
(43) Pub. Date: Sep. 20, 2007

(54) SECURITY SYSTEM AND METHOD FOR IN-VEHICLE REMOTE TRANSMITTER

(75) Inventors: Riad Ghabra, Dearborn Heights, MI (US); Tom Q. Tang, Novi, MI (US); John S. Nantz, Brighton, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/276,779

(22) Filed: Mar. 14, 2006

(51) Int. Cl. G05B 19/00; B60R 25/00

(52) U.S. Cl. 340/5.64; 340/5.71; 340/5.74

(57) ABSTRACT

A security system and method for an in-vehicle remote transmitter that transmits a wireless control signal and has an activation button. A controller determines whether a vehicle status is authorized and permits transmission of the wireless control signal by the in-vehicle remote transmitter if the vehicle status determined is authorized.

### TECHNICAL FIELD

The following relates to a security system and method for an in-vehicle remote transmitter.

A detailed description and accompanying drawing are set forth below.

### BRIEF DESCRIPTION OF THE DRAWINGS

FIG. 1 is a simplified block diagram including the security system described herein; and

FIG. 2 is a flowchart of the security method described herein.

### DETAILED DESCRIPTION

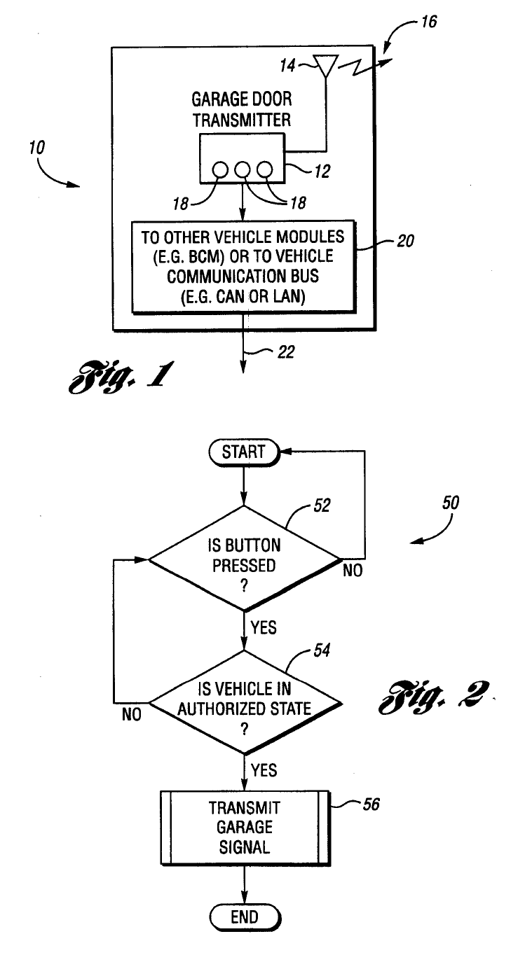

With reference to FIGS. 1 and 2, a more detailed description of the security system and method will now be provided. It is increasingly common for vehicle manufacturers to provide a built-in transmitter for remote wireless control of home appliances or home appliance systems, such as garage door operating systems and the like, home security systems, home lighting, and/or others. Such an in-vehicle remote transmitter is trained or programmed to control such home appliances in any of a number of fashions known to those of ordinary skill in the art.

In that regard, training such an in-vehicle remote transmitter may involve learning and reproducing a wireless control signal from a remote control transmitter provided as part of the home appliance system. In such circumstances, the in-vehicle remote transmitter may include a receiver for receiving a wireless control signal from such an existing remote transmitter. Alternatively, programming such an in-vehicle remote transmitter may involve selecting operating information from a storage device or memory provided with the in-vehicle remote transmitter, according to which the in-vehicle remote transmitter will subsequently operate.

In any event, once trained or programmed, such an in-vehicle remote transmitter allows for operation of a home appliance without the need for the existing remote control transmitter provided with the home appliance. For example, an appropriately trained or programmed in-vehicle remote transmitter allows for operation of a garage door operating system without the need for the existing garage door remote control transmitter.

In operation, therefore, such a trained or programmed in-vehicle remote transmitter allows for entry into a garage, and possibly an attached residence or business. As a result, unauthorized entry into a vehicle having such an in-vehicle remote transmitter may also permit unauthorized entry into such a garage, residence or business.

Thus, there exists a need for a security system and method that would prevent unauthorized use of an in-vehicle remote transmitter for entry into a garage, and possibly a residence or business. That is, there exists a need for a security system and method that would prevent an unauthorized user of a vehicle from using an in-vehicle remote transmitter for unauthorized entry into a garage, residence or business.

Referring now more specifically to FIG. 1, a simplified block diagram of the security system described herein is shown, denoted generally by reference numeral 10. As seen therein, an in-vehicle remote transmitter (12) is provided for control of a home appliance or home appliance system, such as a garage door operating system or the like, a home security system, home lighting, and/or other appliances or systems.

As previously noted, remote transmitter (12) is built-in to a vehicle (not shown), typically as part of a system or component of a vehicle interior. In-vehicle remote transmitter (12) comprises an antenna (14) for use in at least transmitting wireless control signals (16) for controlling a home appliance or home appliance system. In-vehicle remote transmitter (12) also comprises a plurality of buttons (18). Buttons (18) may be provided as activation buttons for activating in-vehicle remote transmitter (12) to transmit wireless control signals (16) when actuated by an operator. Buttons (18) may also be provided as input buttons for inputting information from an operator to in-vehicle remote transmitter (12). Buttons (18) may also be provided with lights or lighted icons either thereon or associated therewith that may act as output devices in order to provide information from in-vehicle remote transmitter (12) to an operator.

Still referring to FIG. 1, to prevent its unauthorized use as described above, the security system may include a controller (20) to determine whether or not the vehicle is in an authorized state. Controller (20) preferably communicates with other vehicle modules or vehicle systems (not shown) for such a determination. Such communication may take place over one or more vehicle buses (22). In that regard, controller (20) may take any of a number of forms, such as a switch, a circuit, or a microprocessor or microcontroller, and may determine whether the vehicle is in an authorized state based simply on receipt of a signal from a vehicle module or system. Controller (20) may alternatively take the form of an existing or additional vehicle module. Although depicted separately in FIG. 1, controller (20) may be separate from, part of, or integrated with transmitter (12).

More specifically, the vehicle may be determined to be in an authorized state by controller (20) where a vehicle key containing a proper immobilization chip has been inserted into the vehicle ignition or, in the case of passive entry, a vehicle transponder fob is within the vehicle. Alternatively, the vehicle may be determined to be in an authorized state upon receipt by the vehicle of a proper wireless remote entry signal, such as a command signal from a remote keyless entry transmitter or any type of signal from a passive entry fob transponder. The status of the vehicle immobilization system or remote entry system, or the reception of any immobilization or remote entry signals can be ascertained via a vehicle bus (22) and/or from a vehicle module, such as an immobilization module, remote entry module, or a body control module (BCM) (not shown). In that regard, a vehicle immobilization system status signal or a vehicle remote entry system status signal may be provided to the controller (20) via a vehicle bus (22).

Still further, a determination whether or not the vehicle is in an authorized state may be made by controller (20) based on whether a key has been inserted into the lock cylinder, and preferably placed in an “accessory” position. In that regard, the power supply of the in-vehicle remote transmitter (12), such as from the vehicle battery, can be made dependent upon such a key insertion. Determination of whether or not the vehicle is in an authorized state in this fashion is a lower cost alternative, but provides a lower level of security since it does not assure that the key inserted in the lock cylinder to place the vehicle in an “accessory” mode is an authorized key.

Further still, the vehicle can be determined to be in an authorized state and/or the in-vehicle remote transmitter (12) can be enabled by controller (20) based on an operator actuating one or more buttons (18) in a proper combination, sequence or pattern. In such a fashion, the in-vehicle remote transmitter (12) may also be enabled for operation by an authorized vehicle operator even in the absence of a proper vehicle ignition key, fob transmitter, or fob transponder.

In-vehicle remote transmitter (12) could also be provided with a controller (20) in the form of a radio frequency or low frequency receiver and/or an authorization system (similar to a vehicle immobilization system) (not shown) well known to those of ordinary skill in the art. In such an embodiment, if the controller (20) receives a proper, authentic, or authenticated signal, such as an identification signal, then the in-vehicle transmitter (12) is enabled, authorised, permitted or allowed to operate or transmit and/or transmits a wireless control signal for controlling a home appliance or home appliance system in response to an operator actuation of an activation button (18). While such an implementation would be less cost effective, in contrast to those described above, such an implementation would provide for direct enablement or authorization of in-vehicle remote transmitter (12).

According to any of the embodiments described, the security system (10) determines whether or not the vehicle is in an authorized state. Such a determination may be made in response to an actuation of an activation button (18) by an operator, or independently. Nevertheless, if the determined vehicle state is authorized, then in-vehicle remote transmitter (12) is enabled, permitted, allowed or authorized to transmit and/or transmits a wireless control signal (20) for controlling a home appliance or home appliance system in response to receiving an input signal representing an actuation of an activation button (18) of in-vehicle remote transmitter (12).

Referring now to FIG. 2, a flowchart of the security method described herein is shown, denoted generally by reference numeral 50. As seen therein, upon receiving (52) an input signal representing an actuation of an activation button by an operator, a determination (54) is made whether or not the vehicle is in an authorized state. As previously described, such a determination may be made based on information from any of a number of vehicle modules and/or systems, such as a body control module, a vehicle immobilization system, a vehicle remote entry system, and/or others.

If the determined (54) vehicle state is not authorized, receipt (52) of an input signal representing an actuation of an activation button by an operator is again checked. However, if the determined (54) vehicle state is authorized, then the in-vehicle remote transmitter is enabled, authorized, permitted, or allowed to transmit and/or transmits (56) a wireless control signal for controlling a home appliance or home appliance system in response to operator actuation of an activation button. It should be noted that the method (50) depicted in FIG. 2 is exemplary, and that the functions of the method (50) could be undertaken other than in the order shown and/or simultaneously as may be desired, permitted and/or possible.

From the foregoing it can be seen that the security system (10) and method (50) described herein overcome the problems noted above. More particularly, the security system (10) and method (50) described herein prevent unauthorized use of an in-vehicle remote transmitter (12) for entry into a garage, and possibly a residence or business. The security system (10) and method (50) described herein do so by determining whether or not the vehicle is in an authorized state. The security system (10) and method (50) described herein may make such a determination based on information from any of a number of vehicle modules and/or systems, such as a body control module, a vehicle immobilization system, a vehicle remote entry system, and/or others.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A security system for an in-vehicle remote transmitter, the transmitter for transmitting a wireless control signal and having an activation button, the system comprising:
a controller for determining, in response to an input signal representing actuation of the activation button by an operator, whether a vehicle status is authorized;
wherein the controller permits transmission of the wireless control signal by the in-vehicle remote transmitter if the vehicle status determined is authorized.

2. The system of claim 1 wherein the controller determines whether the vehicle status is authorized based on a vehicle immobilization system signal.

3. The system of claim 1 wherein the controller determines whether the vehicle status is authorized based on a vehicle remote entry system signal.

4. The system of claim 1 wherein the controller determines whether the vehicle status is authorized based on a presence of a key in a vehicle lock cylinder.

5. The system of claim 4 wherein power is provided to the in-vehicle remote transmitter based on the presence of the key in the vehicle lock cylinder.

6. The system of claim 1 wherein the in-vehicle remote transmitter further comprises a plurality of buttons and the controller determines whether the vehicle status is authorized based on a pattern of actuation of at least one of the plurality of buttons.

7. The system of claim 1 wherein the in-vehicle remote transmitter further comprises a receiver for receiving a wireless signal, and the controller determines whether the vehicle status is authorized based on the wireless signal.

8. A security system for an in-vehicle remote transmitter, the transmitter for transmitting a wireless control signal, the system comprising:
a controller for determining whether a vehicle status is authorized;
wherein the controller enables the in-vehicle remote transmitter for transmission of the wireless control signal if the vehicle status is authorized.

9. The system of claim 8 wherein the controller determines whether the vehicle status is authorized based on a vehicle immobilization system signal.

10. The system of claim 8 wherein the controller determines whether the vehicle status is authorized based on a vehicle remote entry system signal.

11. The system of claim 8 wherein the controller determines whether the vehicle status is authorized based on a presence of a key in a vehicle lock cylinder.

12. The system of claim 11 wherein power is provided to the in-vehicle garage door opener remote transmitter based on the presence of the key in the vehicle lock cylinder.

13. The system of claim 8 wherein the in-vehicle remote transmitter further comprises a plurality of buttons and the controller determines whether the vehicle status is authorized based on a pattern of actuation of at least one of the plurality of buttons.

14. The system of claim 8 wherein the in-vehicle remote transmitter further comprises a receiver for receiving a wireless signal, and the controller determines whether the vehicle status is authorized based on the wireless signal.

15. A security method for an in-vehicle remote transmitter, the transmitter for transmitting a wireless control signal and having an activation button, the method comprising:
receiving an input signal representing actuation of the activation button by an operator;
determining whether a vehicle status is authorized; and
transmitting the wireless control signal if the vehicle status determined is authorized.

16. The method of claim 15 wherein determining whether the vehicle status is authorized is based on a vehicle immobilization system signal.

17. The method of claim 15 wherein determining whether the vehicle status is authorized is based on a vehicle remote entry system signal.

18. The method of claim 15 wherein determining whether the vehicle status is authorized is based on a presence of a key in a vehicle lock cylinder.

19. The method of claim 15 wherein the in-vehicle remote transmitter further comprises a plurality of buttons and determining whether the vehicle status is authorized is based on a pattern of actuation of at least one of the plurality of buttons.

20. The method of claim 15 wherein the in-vehicle remote transmitter further comprises a receiver for receiving a wireless signal, and determining whether the vehicle status is authorized is based on the wireless signal.
